(19) United States
(12) Patent Application Publication
(10) Pub. No.: US 2025/0319782 A1
(43) Pub. Date: Oct. 16, 2025

(54) CHARGING CONNECTOR PART OF A CHARGING SYSTEM FOR ELECTRICALLY CHARGING AN ELECTRIC VEHICLE

(71) Applicant: Phoenix Contact E-Mobility GmbH, Schieder-Schwalenberg (DE)

(72) Inventor: Witalij KNAUB, Aerzen (DE)

(21) Appl. No.: 19/091,906

(22) Filed: Mar. 27, 2025

(30) Foreign Application Priority Data
Apr. 10, 2024 (BE) BE2024/5206

(51) Int. Cl. B60L 53/16; H01R 13/52; H01R 13/639

(52) U.S. Cl. CPC B60L 53/16; H01R 13/5202; H01R 13/5227; H01R 13/639

(57) ABSTRACT

A charging connector part of a charging system for electrically charging an electric vehicle includes: a plug opening within which at least one electrical contact element is arranged, and via which the charging connector part is connectable by plugging with an associated mating connector part; a wall, delimiting the plug opening, on which wall a wall opening is formed; a locking element which movable through the wall opening of the wall into a region of the plug opening so as to lock the charging connector part with the mating connector part; an actuator for adjusting the locking element; and a sealing element having a sealing lip, resting on the locking element, the sealing element sealing a transition between the locking element and the wall. The locking element is movable relative to the sealing lip while sliding against the sealing lip.

### CROSS-REFERENCE TO PRIOR APPLICATION

Priority is claimed to Belgian Patent Application No. BE 2024/5206, filed on Apr. 10, 2024, the entire disclosure of which is hereby incorporated by reference herein.

### FIELD

The invention relates to a charging connector part of a charging system for electrically charging an electric vehicle.

### BACKGROUND

Such a charging connector part comprises a plug opening within which at least one electrical contact element is arranged and via which the charging connector part can be connected by plugging with an associated mating connector part. A wall opening is formed on a wall delimiting the plug opening. A locking element can be moved through the wall opening into the region of the plug opening in order to lock the charging connector part with the mating connector part. An actuator is designed to adjust the locking element.

In such a charging connector part, a locking connection is established between the charging connector part and the associated mating connector part during operation via the locking element, which can be moved by the actuator, when the charging connector part and the mating connector part are connected to one another by plugging. If the mating connector part is plugged into the plug opening of the charging connector part with a correspondingly designed plug portion, the locking element, actuated by the actuator, can be moved into the region of the plug opening via the wall opening on the wall delimiting the plug opening, e.g., to engage in an associated connection opening on the side of the mating connector part and thus establish a locking connection between the charging connector part and the mating connector part, so that the charging connector part and the mating connector part cannot be easily separated from one another, at least not without undoing the locking connection.

Different regions have different standards for the design of mating faces on charging connector parts. For example, charging connector parts are standardized according to the CCS Type 1 standard (CCS1 for short) or CCS Type 2 standard (CCS2 for short), wherein CCS1 charging connector parts are used primarily in North America, for example, while CCS2 charging connector parts are used primarily in Europe. There are also other standards, such as the quasi-standard of the NACS system established in the North American market.

Depending upon the specific standard used for the charging connector part, the design and arrangement of a locking element may vary. For example, such a locking element can be arranged in an upper region of the plug opening (at a so-called 12 o'clock position). In other embodiments, e.g., when using the NACS system, the locking element can be arranged in a lower region of the plug opening (at a so-called 6 o'clock position).

In the case of a charging connector part of the type in question here, care must be taken to ensure that it can be operated reliably over a wide range of ambient conditions. This is to prevent components, in particular the locking element, from freezing at low temperatures, in order to ensure that a locking connection between the charging connector part and the mating connector part can be reliably established and released again even at low ambient temperatures. This applies in particular if, due to the arrangement of the locking element relative to the plug opening, it cannot be ruled out that moisture can enter the region of the locking element.

DE 10 2020 118 121 A1 and DE 10 2015 113 519 A1 disclose solutions for charging connector parts in the form of vehicle-side charging sockets, in which a water drain is provided from the region of a plug opening.

### SUMMARY

In an embodiment, the present invention provides a charging connector part of a charging system for electrically charging an electric vehicle, comprising: a plug opening within which at least one electrical contact element is arranged, and via which the charging connector part is connectable by plugging with an associated mating connector part; a wall, delimiting the plug opening, on which wall a wall opening is formed; a locking element which movable through the wall opening of the wall into a region of the plug opening so as to lock the charging connector part with the mating connector part; an actuator configured to adjust the locking element; and a sealing element having a sealing lip, resting on the locking element, the sealing element being configured to seal a transition between the locking element and the wall, wherein the locking element is movable relative to the sealing lip while sliding against the sealing lip.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a view of a charging system for charging an electric vehicle;

FIG. 2 is a view of an exemplary embodiment of a charging connector part in the form of a charging plug of an electric vehicle;

FIG. 3 is another view of the charging connector part with an actuator for adjusting a locking element;

FIG. 4 is another view of the arrangement according to FIG. 3;

FIG. 5 is a longitudinal sectional view through a charging connector part in the region of a locking element to be adjusted via an actuator;

FIG. 6A is a separate view of a spacer with a sealing element arranged thereon according to the exemplary embodiment of FIG. 5;

FIG. 6B is another view of the spacer according to FIG. 6A;

FIG. 7 is a longitudinal sectional view through a charging connector part in the region of a locking element to be adjusted via an actuator, according to a further exemplary embodiment;

FIG. 8A is a view of a spacer, with a sealing element arranged thereon, according to the exemplary embodiment of FIG. 7; and

FIG. 8B shows another view of the spacer.

### DETAILED DESCRIPTION

In an embodiment, the present invention provides a charging connector part and a charging system for charging an electric vehicle which enable reliable operation in a wide range of environmental conditions, in particular with regard to the establishment of a locking connection with a mating connector part.

Accordingly, the charging connector part has a sealing element which has a sealing lip, resting on the locking element, for sealing a transition between the locking element and the wall, wherein the locking element is movable relative to the sealing lip while sliding against it.

In the charging connector part, the locking element can be moved through the wall opening on the wall delimiting the plug opening, into the region of the plug opening, in order to establish a locking connection with an associated mating connector part when the mating connector part has been plugged, with an associated plug portion, into the plug opening of the charging connector part. In a locking position, the locking element protrudes through the wall opening and into the region of the plug opening in order to lock with the mating connector part within the plug opening. Conversely, the locking element can be withdrawn from the region of the plug opening so that, in an unlocking position, the locking element does not protrude, or protrudes only insignificantly, into the region of the plug opening relative to the wall, and thus the locking with the mating connector part is released.

Also, depending upon the positioning of the wall opening and the locking element in the plug opening, it cannot be ruled out in principle that moisture will enter the region of the locking element. In order to nonetheless reduce the risk of freezing, particularly at low ambient temperatures, a sealing element is provided which rests against the locking element with a sealing lip and seals a transition between the locking element and the wall. The locking element can be moved relative to the sealing element so that the sealing lip slides on the locking element, when the locking element is adjusted, between the locking position and the unlocking position. Due to the contact of the sealing lip with the locking element, moisture can be wiped off the locking element and does not reach a region beyond the sealing element, so that the risk of freezing due to the presence of moisture in the region of the locking element is at least reduced.

In one embodiment, the wall forms a floor which delimits the plug opening downwards when used as intended. The wall is thus arranged in a lower region of the plug opening and delimits the plug opening downwards. The wall opening is formed on the wall, through which opening the locking element can be moved between the locking position and the unlocking position. In the locking position, the locking element protrudes into the region of the plug opening in order to establish a locking connection with a plugged-in mating connector part. In the unlocking position, the locking element is retracted from the region of the plug opening compared to the locking position, so that the locking connection is released.

The locking element can in particular be arranged in a central, lower position relative to the plug opening (so-called 6 o'clock position). Moisture can therefore in principle reach the region of the locking element, but cannot flow through between the locking element and the wall, because a transition between the locking element and the wall is sealed by the sealing element. When the locking element moves relative to the wall and thus relative to the scaling element, the moisture is wiped off via the sealing lip on the locking element, so that the risk of freezing due to moisture present on the locking element is at least reduced.

In one embodiment, the sealing element has a through-opening. The scaling lip extends around the through-opening. The locking element extends through the through-opening. The sealing lip thus extends around the locking element and is in contact with the locking element along a peripherally closed contact line. A transition between the wall and the locking element is thus reliably sealed by the sealing element, so that moisture cannot collect on the locking element in a region on the other side of the wall (viewed from the side of the plug opening).

In one embodiment, the sealing element can be formed by an O-ring. In another embodiment, the sealing element can be formed, for example, as a flat, elastic element—for example, made of a silicone material.

In one embodiment, the sealing element rests on a side, facing away from the plug opening, of the wall. The wall delimits the plug opening—for example, in a lower region. The wall opening is formed in the wall, through which opening the locking element can be moved. The sealing element rests on a side, facing away from the plug opening, of the wall and thus provides a seal between the wall and the locking element on the side facing away from the plug opening.

The wall can for example have a thickness between 1 mm and 3 mm—for example, 1.5 mm. Because the sealing element with the sealing lip formed thereon is arranged on the other side of the wall when viewed from the side of the plug opening, an edge delimiting the wall opening can serve as a support for the locking element, particularly in a load case. If the charging connector part is connected to an associated mating connector part and locked via the locking element, the locking element can be supported on the edge, delimiting the wall opening, of the wall when tensile forces or compressive forces occur (in relation to a plug-in direction along which the mating connector part is plugged into the plug opening of the charging connector part), so that excessive loading on the locking element is avoided.

In one embodiment, the wall forms a drainage channel, adjoining the wall opening, for draining moisture from the region of the plug opening. The locking element can be moved through the wall opening in order to adjust the locking element between the locking position and the unlocking position. If a seal is provided via the sealing element on a side facing away from the plug opening, moisture can in principle reach the region of the wall opening and thus possibly collect in the wall opening. To counteract this, a drainage channel is formed on the wall, along which channel moisture can drain away from the region of the wall opening. The drainage channel can in particular be extended along the wall in such a way that, when the charging connector part is installed in the intended position, e.g., on a vehicle, a moisture flow along the drainage channel occurs due to the acting gravity, and moisture thus automatically flows out of the region of the wall opening along the drainage channel if moisture gets into the region of the wall opening.

Preferably, when the charging connector part is installed as intended, e.g., on a vehicle, the drainage channel is inclined in such a way that, even when the vehicle is in an inclined position, e.g., when parked on a slope, moisture can reliably flow away from the region of the wall opening along the drainage channel.

The drainage channel can, for example, be formed by a channel-shaped depression or recess in the wall.

In one embodiment, the wall forms a drainage opening for draining moisture from the plug opening. The drainage channel extends between the wall opening and the drainage opening on the wall. Moisture can flow out of the region of the plug opening via the drain opening, wherein the drain opening is in flow connection, e.g., with an associated drain line, via which moisture can be drained from the charging connector part. Moisture that reaches the region of the wall opening on the wall of the plug opening is guided to the drain opening via the drainage channel and thus drained away.

The drainage channel preferably has a floor which is flush with the position of the sealing element relative to the locking element, so that moisture can reliably flow from the locking element into the drainage channel and thus drain away.

In one embodiment, the sealing element has a surface portion which forms a floor of the drainage channel. The drainage channel can, for example, be formed as a channel-shaped recess in the wall, wherein a floor of the drainage channel is formed by the surface portion of the sealing element. Because the sealing element forms the floor of the drainage channel, the floor of the drainage channel is at the same height as a portion of the sealing element in the region of the locking element, so that moisture cannot collect in the region of the locking element, but can reliably flow away from the locking element along the drainage channel.

In one embodiment, the locking element is movable longitudinally along a longitudinal axis relative to the wall. The locking element can in particular be designed as a pin-like element which extends longitudinally along the longitudinal direction and can be moved by the actuator.

The actuator can, for example, be designed as an electromotive actuator and is used to adjust the locking element relative to the wall of the plug opening.

In one embodiment, the sealing element is curved with respect to a cross-sectional plane spanned by the longitudinal axis and a transverse direction pointing transversely to the longitudinal axis. In particular, the sealing element can be concavely curved on a side facing the plug opening. The sealing element thus extends along a concavely curved plane, in particular on the side facing the plug opening. There can be such a concave curvature on the sealing lip of the sealing element. Such a concave curvature can also be present on a surface portion forming the floor of a drainage channel, so that moisture can reliably flow away along the concave sealing element.

In one embodiment, the sealing element is formed entirely from a silicone material—for example, an LSR material. The sealing element can, for example, assume a (direct or indirect) intermediate position between the wall delimiting the plug opening and the actuator, and in this way can also compensate for tolerances in the position of the actuator relative to a housing of which the wall is a component.

In one embodiment, the charging connector part has a spacer on which the sealing element is arranged and which is attached to the wall. The spacer can, for example, be formed from a plastic material and is rigidly formed compared to the elastically deformable sealing element. For example, the spacer and the sealing element can be molded together in one piece as a 2-component part by 2-component injection molding, by the spacer and the sealing element being molded together from different materials in an injection-molding tool.

In one embodiment, the spacer is arranged between the actuator and the wall. The spacer thus represents an intermediate element arranged between the actuator and the wall. For example, the actuator can be screwed to a housing that forms the wall of the plug opening, with the spacer being clamped between the actuator and the wall. Because the sealing element is arranged on the spacer and rests against the wall in order to provide a seal between the wall and the adjustable, relative to the wall, locking element, the sealing element can also provide tolerance compensation in the position of the actuator relative to the wall.

In one embodiment, the spacer has an opening in which the locking element is movable. The spacer occupies an intermediate position between the actuator and the wall. The opening of the spacer is aligned with the wall opening on the wall of the plug opening, so that the locking element can be moved through the opening of the spacer and the wall opening relative to the wall so as to protrude into the region of the plug opening relative to the wall in the locking position and to lock with a mating connector part inserted into the plug opening, while, in the unlocking position, the locking element is retracted such that a locking connection with the mating connector part is released.

In one embodiment, the spacer has a connection piece for connecting a drain line for draining away moisture. The connection piece is preferably in flow connection with a drain opening on the wall of the plug opening. In the operating position, a drain line is connected to the charging connector part via the connection piece so that moisture that collects in the plug opening can flow away via the connection piece and the drain line connected to it. In this case, the sealing element can act as an axial seal between the spacer and the wall to prevent moisture from entering a region on the other side of the spacer, between the spacer and the wall.

The charging connector part can in particular be an NACS connector, i.e., a connector in the NACS system with a plugging face according to the NACS specifications.

A charging system for charging an electric vehicle comprises a charging connector part of the type described above and a mating connector part for connection by plugging with the charging connector part. The charging connector part can in particular be a charging socket arranged on the vehicle. In contrast, the mating connector part can preferably be designed as a charging plug on a charging cable connected to a charging station. The mating connector part can be connected to the charging connector part, in the form of the vehicle-side charging socket, by inserting, in a plug-in direction, a plug portion of the mating connector part into the plug opening of the charging connector part, and by electrical contact elements of the charging connector part coming into electrical connection with associated mating contact elements of the mating connector part.

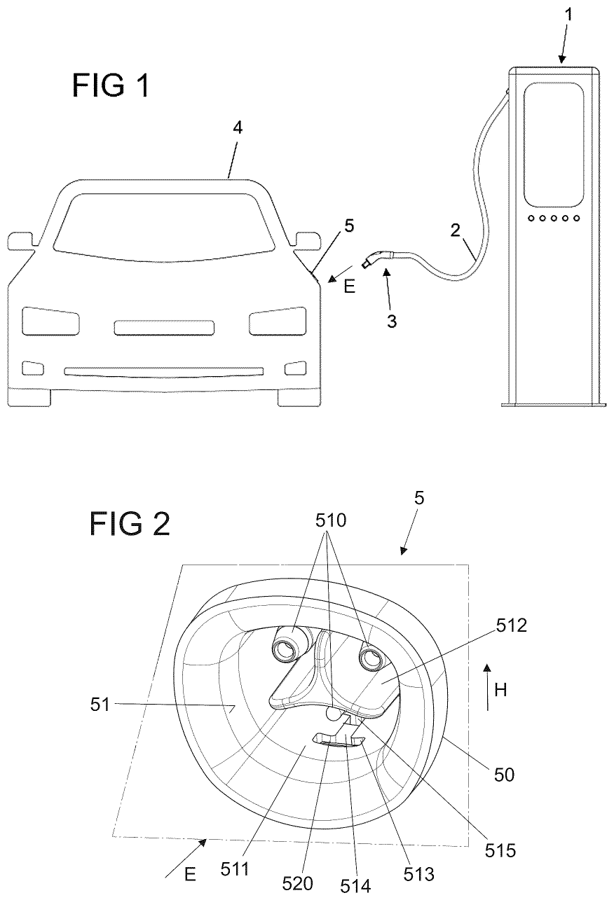

FIG. 1 shows a charging system for charging an electric vehicle 4. The charging system comprises a charging station 1 to which a charging plug 3 is connected via a charging cable 2. On the electric vehicle 4, a charging socket 5 is arranged, to which the charging plug 3 is to be connected in order to establish a connection between the charging station 1 and the electric vehicle 4 and to charge batteries of the electric vehicle 4.

FIG. 2 shows an exemplary embodiment of a charging connector part 5 in the form of a charging socket which is designed for use on a vehicle 4 and which forms a plug opening 51, within which electrical contact elements 510 are arranged for transmitting a charging current and possibly also control signals. The contact elements 510 are separated from one another by a partition wall element 512, so that the contact elements 510 are arranged in separate compartments within the plug opening 51, and sufficient air and creepage distances are ensured. An associated mating connector part 3 in the form of a charging plug can be inserted into the plug opening 51 along a plugging direction E in order to establish an electrical connection between the charging station 1 and the vehicle 4 (see FIG. 1).

The plug opening 51 is delimited by an inner, surrounding wall 511.

As can be seen from FIG. 2, the wall 511 forms (among other things, also) a floor of the plug opening 51, which, when the charging connector part 5 is installed in the intended position on a vehicle 4, is arranged in a lower region of the plug opening 51 and delimits the plug opening 51 downwards. A wall opening 513 is formed on this floor, through which opening a locking element 520 can be adjusted in order to lock a mating connector part 3, inserted into the plug opening 51 of the charging connector part 5, with the charging connector part 5 in a locking position, so that the mating connector part 3 and the charging connector part 5 cannot be easily separated from one another, at least not without releasing the locking connection.

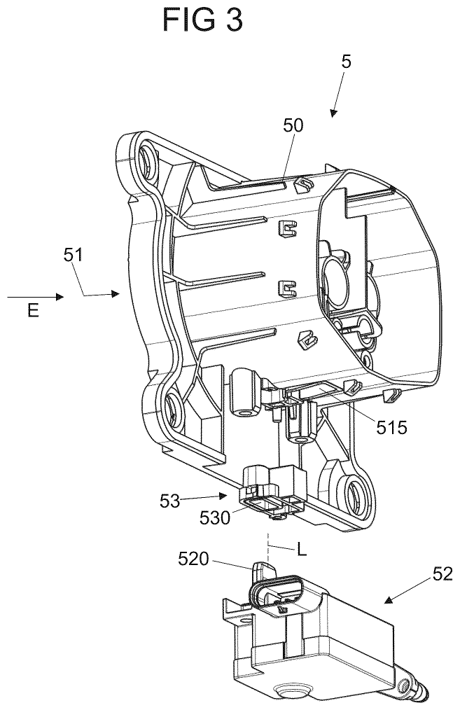

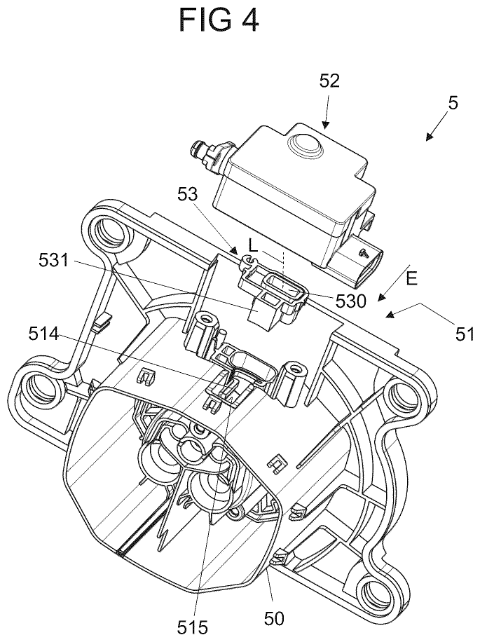

Referring now to FIGS. 3 to 6A, 6B, the locking element 520 is formed by a locking pin which is adjustable along a longitudinal axis L and which can be moved relative to the plug opening 51 via an actuator 52, e.g., an electromotive actuator, so as to protrude into the region of the plug opening 51 in a locking position (corresponding to the position in FIG. 5) and thus establish a locking connection with an inserted mating connector part 3.

In the illustrated exemplary embodiment, the actuator 52 is supported on the wall 511 via a spacer 53 arranged between the wall 511 and the actuator 52. The spacer 53 forms an opening 530 which is aligned with the wall opening 513 of the wall 511 and in which the locking element 520 can be moved in order to adjust the locking element 520 between the locking position and the unlocking position.

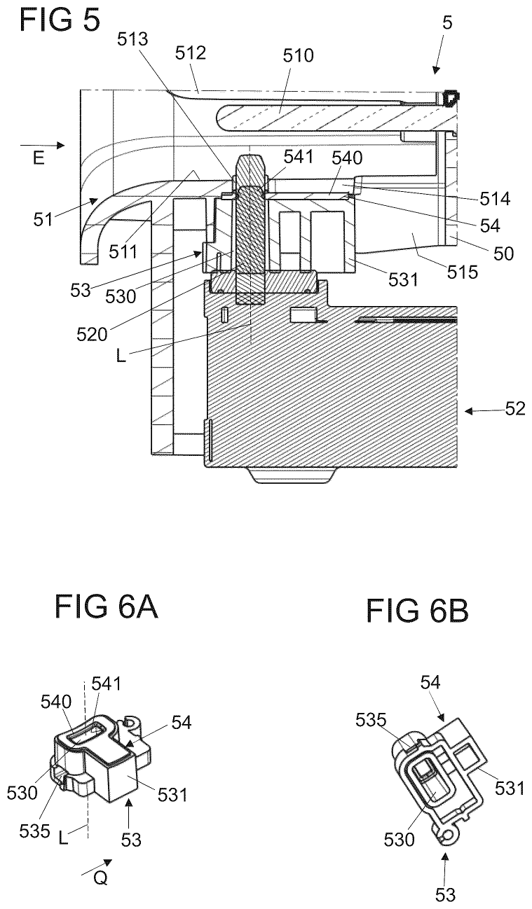

In the exemplary embodiment shown, a sealing element 54 is arranged on the spacer 53, which sealing element forms a through-opening 541 with a sealing lip 540 surrounding the through-opening 541. The through-opening 541 is aligned with the opening 530 of the spacer 53 so that the locking element 520 extends through the through-opening 541, with the sealing lip 540 resting on the locking element 520 in a sealing manner, as can be seen from FIG. 6A in conjunction with the sectional view according to FIG. 5.

A seal is created between the wall 511 and the locking element 520 via the sealing element 54 and the sealing lip 540 formed thereon. Here, the sealing element 54 is arranged together with the spacer 53, viewed from the side of the plug opening 51, on the other side of the wall 511, and rests on a side, facing away from the plug opening 51, of the wall 511. The sealing element 54 occupies an intermediate position between the wall 511 and the spacer 53, as can be seen from FIG. 5.

Because the locking element 520 extends through the through-opening 541, and the sealing lip 540 rests against the locking element 520, the sealing lip 540 slides on the surface of the locking element 520 when the locking element 520 is adjusted and can wipe moisture off the locking element 520. Moisture therefore cannot pass between the scaling element 520 and the wall 511 into the region of the opening 530 of the spacer 53 and into the region of the actuator 52.

The wall 511 forms a drainage channel 514 adjoining the wall opening 513, the floor of which channel is formed by a surface portion 542 of the sealing element 54, as can be seen from FIG. 2 in conjunction with the sectional view in FIG. 5. The surface portion 542 of the sealing element 54 rests on a support portion 531 of the spacer 53, so that the surface portion 542 is structurally fixed relative to the wall 511.

The drainage channel 514, formed by a channel-shaped recess in the wall 511, drains moisture that reaches the region of the wall opening 513 towards a drainage opening 515. The moisture can drain from the region of the plug opening 51 via the drain opening 515, so that moisture cannot collect within the plug opening 51, in particular not in the region of the locking element 520.

Because moisture can in this way reach the region of the locking element 520 at the floor of the plug opening 51, but is reliably drained away via the drainage channel 514 and the drainage opening 515, and because a transition on the locking element 520 into a region past the wall 511 is sealed via the sealing lip 540, moisture cannot collect on the locking element 520. Even at low temperatures, the risk of the locking element 520 freezing is thus considerably reduced.

Because the floor of the drainage channel 514 is formed by the surface portion 542 of the sealing element 54, the floor of the drainage channel 514 is flush with the sealing lip 540. A step or other undercut between the drainage channel 514 and the wall opening 513 is thus avoided, so that a reliable drainage of moisture from the region of the wall opening 513 is ensured.

Because the sealing element 54 is arranged on the other side of the wall 511, viewed from the side of the plug opening 51, a surrounding edge of the wall opening 513 can support the locking element 520. If compressive or tensile forces act upon the locking element 520 along the insertion direction E in the locked position, the locking element 520 can be supported on the surrounding edge, formed by the wall 511, of the wall opening 513, so that loading forces on the locking element 520 are absorbed and dissipated.

Due to the intermediate position of the sealing element 540 between the wall 511 and the spacer 53, the sealing element 54 can also enable tolerance compensation for the position of the actuator 52 relative to a housing 50, forming the wall 511, of the charging connector part 5.

The actuator 52 is, for example, screwed to the housing 50. The spacer 53 can, for example, be clamped between the actuator 52 and the wall 511 of the housing 50.

When installed in the intended position, the charging connector part 5 on the vehicle 4 is in particular inclined such that moisture can reliably drain away along the drainage channel 514 in the direction of the drainage opening 515. The inclination of the drainage channel 514 is here preferably such that reliable drainage of moisture is ensured even when the vehicle 4 is in an inclined position—for example, when parked on a slope.

The spacer 53 and the sealing element 54 are preferably formed from one piece—for example, as a 2-component part by 2-component injection molding.

As can be seen from FIG. 6A, 6B, the spacer 53 has a vent opening 535 which extends between an outer region of the spacer 53 and the opening 530, and vents the opening 530 to the outside. Should moisture penetrate into the interior of the opening 530 (for example, in the event of a fault), the opening 530 can dry out via the vent opening 535.

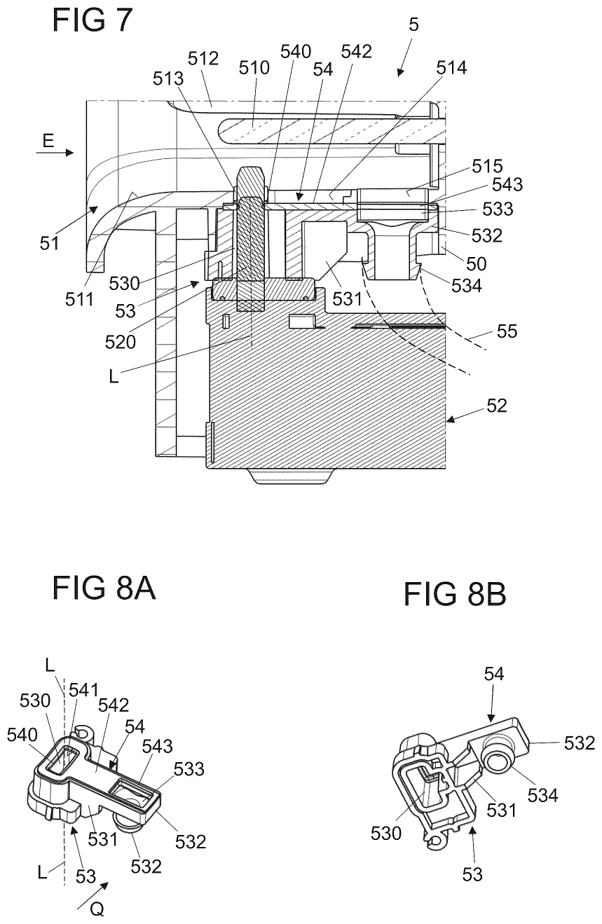

In another exemplary embodiment shown in FIG. 7, 8A, 8B, the spacer 53 additionally has a drain nozzle 534 on a portion 532 adjoining the support portion 531. The drain nozzle 534 enables the connection of a drain line 55 and is aligned with an opening 533 within the portion 532 and, via it, with the drain opening 515 on the wall 511 of the charging connector part 5, so that moisture can be introduced into the connected drain line 55 via the drain opening 515 and the drain nozzle 534, and can be drained via these.

Such a design of a spacer 53 is particularly advantageous when a region of the housing 50 on the other side of the plug opening 51 is formed as a dry space, and thus penetration of moisture into a region on the other side of the wall 511 is to be avoided.

In the exemplary embodiment according to FIG. 7, 8A, 8B, the sealing element 54 forms an opening 543 on the surface portion 542 which extends over the support portion 531 and the portion 532 of the spacer 53, which opening 543 is aligned with the opening 533 in the portion 532 of the spacer 53. The sealing element 54 assumes an intermediate position between the wall 511 and the spacer 53 and forms an axial seal between the spacer 53 and the wall 511.

In the exemplary embodiments shown, the sealing element 54 is concavely curved on a side facing the wall 511, in that the sealing element 54 extends along a plane which is curved in a cross-sectional plane (spanned by the longitudinal axis L and a transverse direction pointing transversely to the longitudinal axis L). The sealing element 54 is thus concavely curved towards the wall opening 513 and the drainage channel 514 so that moisture can reliably flow away at the sealing element 54.

The idea forming the basis of the invention is not limited to the exemplary embodiments described in the preceding, but can also be realized in another way.

In the exemplary embodiment shown, the charging connector part is realized according to the NACS system. However, the charging connector part can also have a different connector face according to a different standard.

The sealing element allows moisture to be drained from the locking element in a passive manner in order to reduce the risk of freezing at low temperatures. Active means, such as the provision of a heating element on the locking element, are generally not required. This makes possible a simple, cost-effective design with reliable operation of the locking element even at low temperatures.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Charging station
2 Charging cable
3 Charging plug
4 Vehicle
5 Charging socket
50 Housing
51 Plug opening
510 Contact elements
511 Wall (floor)
512 Partition wall element
513 Wall opening
514 Drainage channel
515 Drain opening
52 Actuator
520 Locking element
53 Spacer
530 Opening
531 Support portion
532 Drainage portion
533 Opening
534 Connecting piece
535 Vent opening
54 Scaling element
540 Scaling lip
541 Through-opening
542 Surface portion
543 Opening
55 Drain line
E Insertion direction
H Height direction
L Longitudinal axis
Q Transverse direction

1. A charging connector part of a charging system for electrically charging an electric vehicle, the charging connector part comprising:
a plug opening within which at least one electrical contact element is arranged, and via which the charging connector part is connectable by plugging with an associated mating connector part;
a wall, delimiting the plug opening, on which wall a wall opening is formed;
a locking element which movable through the wall opening of the wall into a region of the plug opening so as to lock the charging connector part with the mating connector part;
an actuator configured to adjust the locking element; and
a sealing element having a sealing lip, resting on the locking element, the sealing element being configured to seal a transition between the locking element and the wall,
wherein the locking element is movable relative to the sealing lip while sliding against the sealing lip.

2. The charging connector part of claim 1, wherein the wall forms a floor that delimits the plug opening downwards in an intended use.

3. The charging connector part of claim 1, wherein the sealing element has a through-opening,
wherein the sealing lip extends around the through-opening, and
wherein the locking element extends through the through-opening.

4. The charging connector part of claim 1, wherein the sealing element rests on a side, facing away from the plug opening, of the wall.

5. The charging connector part of claim 1, wherein the wall forms a drainage channel, adjoining the wall opening, for draining moisture from the region of the plug opening.

6. The charging connector part of claim 5, wherein the wall forms a drainage opening configured to drain moisture from the plug opening, and
wherein the drainage channel extends between the wall opening and the drain opening on the wall.

7. The charging connector part of claim 5, wherein the sealing element comprises a surface portion that forms a floor of the drainage channel.

8. The charging connector part of claim 1, wherein the locking element is movable longitudinally along a longitudinal axis relative to the wall.

9. The charging connector part of claim 8, wherein the sealing element is curved with respect to a cross-sectional plane that is spanned by a longitudinal axis and a transverse direction pointing transversely to the longitudinal axis.

10. The charging connector part of claim 9, wherein the sealing element is concavely curved on a side facing the plug opening.

11. The charging connector part of claim 1, wherein the sealing element comprises a silicone material.

12. The charging connector part of claim 1, further comprising:
a spacer on which the sealing element is arranged and that is attached to the wall.

13. The charging connector part of claim 12, wherein the spacer and the sealing element are formed together as a 2-component part by 2-component injection molding.

14. The charging connector part of claim 12, wherein the spacer is arranged between the actuator and the wall.

15. The charging connector part of claim 12, wherein the spacer has an opening in which the locking element is movable.

16. The charging connector part of claim 12, wherein the spacer has a connection piece configured to connect a drainage line so as to drain moisture.

17. The charging connector part of claim 1, wherein the charging connector part comprises an NACS plug connector.

18. A charging system for charging an electric vehicle, comprising:
the charging connector part of claim 1; and
a mating connector part for connection by plugging with the charging connector part.

19. The charging system of claim 18, wherein the charging connector part comprises a charging socket arranged on the vehicle, and
wherein the mating connector part comprises a charging plug on a charging cable.
